(19) United States
(12) Patent Application Publication
(10) Pub. No.: US 2011/0085470 A1
(43) Pub. Date: Apr. 14, 2011

(54) APPARATUS AND METHOD FOR INTEGRATED SIGNAL PROCESSING FOR IP-BASED CONVERGENCE NETWORK

(75) Inventors: No Ik PARK, Daejeon (KR); Soon Seok Lee, Daejeon (KR); Young Boo Kim, Gongju (KR)

(73) Assignee: Electronics and Telecommunications Research Institute, Daejeon (KR)

(21) Appl. No.: 12/902,108

(22) Filed: Oct. 11, 2010

(30) Foreign Application Priority Data
Oct. 12, 2009 (KR) 10-2009-0096763
Sep. 29, 2010 (KR) 10-2010-0094527

(51) Int. Cl. H04L 12/28; H04L 12/66

(52) U.S. Cl. 370/254; 370/352

(57) ABSTRACT

In an apparatus and method for integrated signal processing for an IP-based wired and wireless convergence network, based on an ID of a second user acquired in response to a service call request from a first user terminal, a unique address corresponding to the ID is acquired. The location address corresponding to the unique address, acquired from the address information of the terminals being stored and managed, i.e., the transport address of the second user terminal, is acquired. An IP connection request is sent to the acquired transport address of the second user terminal and the transport address of the first user terminal, and upon completion of the IP connection, data traffic for the requested service is transferred.

### CROSS-REFERENCE TO RELATED APPLICATION

This application claims priority to and the benefit of Korean Patent Application No. 10-2009-0096763 and No. 10-2010-0094527 filed in the Korean Intellectual Property Office on Oct. 12, 2009 and Sep. 29, 2010, the entire contents of which are incorporated herein by reference.

### BACKGROUND OF THE INVENTION

(a) Field of the Invention

The present invention relates to signal processing for network and service controls, and more particularly, to an apparatus and method for network layer-based integrated signal processing for an IP (Internet protocol)-based wired and wireless convergence network.

(b) Description of the Related Art

In general, call control and connection control are separated in a telecommunication network in order to access and control end-to-end services. In the case of call control, call identification, setup, and release are performed, the locations and consistency of transmitting and receiving terminals are checked, and then a negotiation for connection to services, such as QoS (quality of service), is conducted. In the case of connection control, functions such as resource control of an end-to-end physical connection path are performed after call control is performed as described above.

However, at present, functional separation between call control and connection control on an IP network is ambiguous, and call control and connection control are being redundantly applied.

A layered structure pursued by a next generation network (NGN) includes a service control stratum and a transport control stratum. The service control stratum is in charge of IMS (IP multimedia subsystem)-based service control. The transport control stratum performs the location management and mobility control of an IP terminal by the MMCF (mobility management control function) of an ITU-T (International Telecommunication Union-Telecommunication Standardization Sector), and performs end-to-end QoS control and on-path resource control by an RACF (resource and admission control function).

However, this hierarchical structure is disadvantageous in that the functions of each layer are redundant. More specifically, the service control stratum performs the functions including managing the location of an opposing party and checking the availability of the opposing terminal by the user registration function of the IMS in order to establish an end-to-end call. Incidentally, the transport control stratum, which is a network layer, performs IP mobility control. This function, apart from the IMS, supports end-to-end IP connectivity by performing the location management of an IP terminal. Accordingly, it can be regarded that these functions are redundantly performed by the service control stratum and the transport control stratum.

Moreover, the IMS performs policy-based QoS control of each call (SIP session). It can be regarded that, as automatic QoS control of each traffic flow using 5-tuple information of IP traffic is enabled in the transport control stratum as well with the development of the functions of network equipment, the QoS control function is redundant between layers.

Further, the current control structure for service traffic of an IP network will be discussed. The service traffic of application services, associated with an SIP (session initiation protocol) signaling procedure, such as VoIP (voice over Internet protocol), is permitted to enter the network under the control of the IMS, whereas the service traffic of services, such as WWW service, not associated with the SIP signaling procedure enters the network without any restrictions as long as a user is connected to the network. Therefore, the current control structure is not able to prevent the network from being contaminated with harmful traffic or non-permitted traffic. Subsequently, a function for integratedly controlling an SIO/non-SIP-based service is required.

On the other hand, the current IP network has a complicated control structure in which SIP protocol-based signaling for service connection, signaling for VPN (virtual private network) setup, signaling for QoS control, signaling for mobility control, etc. are present, and separate signaling procedures are performed for each function.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus and method for integrated signal processing, which can perform various control functions for service provision in an integrated manner regardless of wired and wireless networks.

Furthermore, the present invention has been made in an effort to provide an apparatus and method for network layer-based integrated signal processing optimized for an IP network, which can eliminate the complexity of an IMS-based service control structure and simultaneously perform security/QoS/mobility/access/VPN controls regardless of wired and wireless networks.

According to an aspect of the present invention, a method for integrated signal processing is provided, in which, in a convergence network having wired and wireless networks connected to an IP network, an integrated signal processing apparatus connected to the IP network performs call processing between terminals, the method including: acquiring a unique address and transport address of a second user terminal based on an ID of the second user acquired from a first user terminal connected to the wired network or the wireless network; sending an IP connection request to the first and second user terminals respectively corresponding to the acquired transport addresses; receiving responses to the IP connection request from the first user terminal and the second user terminal, and completing an IP connection between the first user terminal and the second user terminal based on service policy control information of the first and second user terminals; registering a service corresponding to a request from the first user terminal; and permitting transmission and reception of data traffic corresponding to the registered service between the first user terminal and the second user terminal.

According to another aspect of the present invention, an apparatus for integrated signal processing is provided, which, in a convergence network having wired and wireless networks connected to an IP network, is connected to the IP network to process signals, the apparatus including: a first processing unit that establishes an IP connection between a first user terminal and a second user terminal based on address information of the first and second user terminals in response to a request for a service call with the second user terminal from the first user terminal connected to the wired network or wireless network; and a second processing unit that registers a service between the first and second user terminals between which the IP connection is established, permits data traffic using the protocol of an application corresponding to the registered service to enter, and performs data traffic transfer for the requested service between the terminals.

### BRIEF DESCRIPTION OF THE DRAWINGS

FIG. 1 is an illustration of a network to which an apparatus and method for integrated signal processing according to an exemplary embodiment of the present invention is applied.

FIG. 2 is a structural diagram of the integrated signal processing apparatus according to an exemplary embodiment of the present invention.

FIGS. 3A and 3B are flowcharts of a method for integrated signal processing according to a first exemplary embodiment of the present invention.

FIG. 4 is a view showing a structure of a call request message according to an exemplary embodiment of the present invention.

FIGS. 5A and 5B are flowcharts of a method for integrated signal processing according to a second exemplary embodiment of the present invention.

FIG. 6 is a view showing a structure of a service registration message according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

In the specification, a terminal (UT) may designate a mobile station (MS), a terminal, a mobile terminal (MT), a subscriber station (SS), a portable subscriber station (PSS), user equipment (UE), an access terminal (AT), etc., and may include the entire or partial functions of the mobile terminal, the subscriber station, the portable subscriber station, the user equipment, etc.

In the specification, a network access device may designate an access router, an access point (AP), a base station (BS), a radio access station (RAS), a node B, a base transceiver station (BTS), a mobile multihop relay (MMR)-BS, etc., and may include the entire or partial functions of the access point, the radio access station, the node B, the base transceiver station, the MMR-BS, etc.

Hereinafter, an apparatus and method for integrated signal processing according to an exemplary embodiment of the present invention will be described with reference to the accompanying drawings.

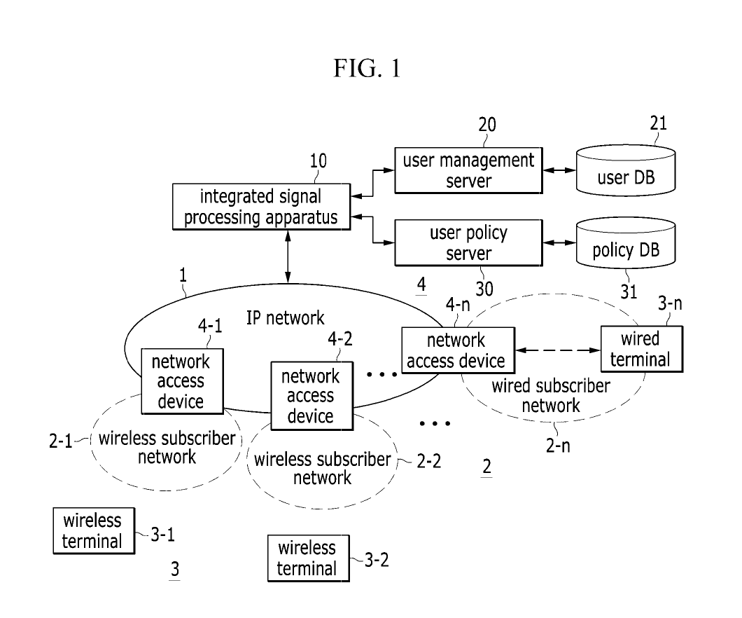

FIG. 1 is an illustration of a network to which an apparatus and method for integrated signal processing according to an exemplary embodiment of the present invention is applied.

In the accompanying FIG. 1, an IP network 1 is connected to wired or wireless subscriber networks, i.e., subscriber networks 2-1, 2-2, . . . , 2-n (for convenience of explanation, “2” is assigned as the representative number, where n is an integer), and wired or wireless terminals 3-1, 3-2, . . . , 3-n (for convenience of explanation, “3” is assigned as the representative number) connected to the subscriber networks 2 are connected to the IP network 1 through network access devices 4-1, 4-2, . . . , 4-n (for convenience of explanation, “4” is assigned as the representative number).

The IP network 1 provides services based on service level agreements (SLAs) that vary depending on individual users.

The network access devices 4-1, 4-2, . . . , 4-n are located at interconnection points between the IP network 1 and the subscriber networks 2-1, 2-2, . . . , 2-n, and process an IP packet, bind and record the IP address of a packet transmitted from a terminal 3 and terminal information, and determine whether the corresponding terminal 3 is connected to the IP network.

The terminals 3-1, 3-2, . . . , 3-n may be provided with client/server-based network services and network services according to end-to-end communication with other mobile terminals. Moreover, the terminal 3 according to the exemplary embodiment of the present invention is equipped with a client capable of processing an integrated signal for security control, QoS control, mobility control, connection control, and VPN control.

In order to simultaneously process various controls regardless of wired/wireless terminals in such a network environment, an integrated signal processing apparatus 10 according to the exemplary embodiment of the present invention is connected to the IP network 1, and interoperates with a user management server 20 and a user policy server 30.

The user management server 20 manages address information assigned to a user to recognize the user, along with the IP address, in the network. Specifically, the user management server 20 stores and manages various information about subscribers who can access the IP network according to the exemplary embodiment of the present invention, and in particular, it binds unique and location addresses provided from a terminal and stores and manages them as address information. Address information of a terminal according to the exemplary embodiment of the present invention will be described in further detail later. Further, the user management server 20 may include a user database 21 for managing address information of terminals of users, and the address information acquired from the terminals are stored and managed, corresponding to the IDs of the corresponding users, in the user database 21.

The user policy server 30 records and manages network and service policies for each user. The user policy server 30 stores and manages service policy control information, including a resource allocation policy for each service, the total amount of traffic allowed for each subscriber, and traffic usage. To this end, the user policy server 30 may include a policy database 31, and service policy control information of a user is stored and managed, corresponding to the user ID, in the policy database 31.

In the IP network 1 according to the exemplary embodiment of the present invention, various functions are required to recognize subscribers using various types of terminals through various types of wired/wireless subscriber networks and effectively provide mobility services to the terminals. For example, security control, mobility control, connection control, QoS control, VPN control, etc. for preventing a network from being contaminated with harmful traffic or non-permitted traffic are required, and the exemplary embodiment of the present invention provides the integrated signal processing apparatus 10 capable of simultaneously performing these controls.

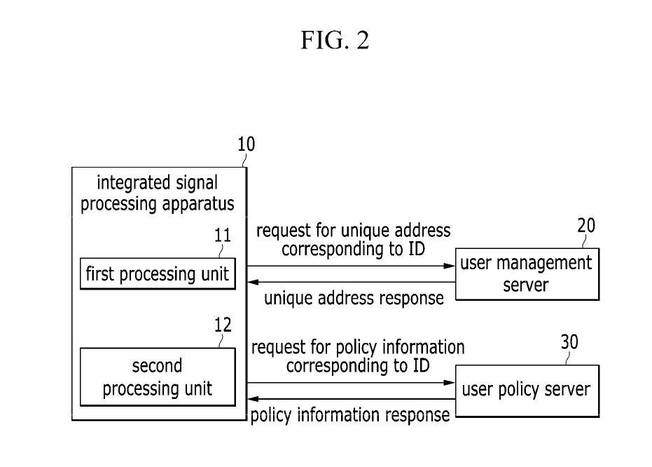

FIG. 2 is a structural diagram of the integrated signal processing apparatus according to an exemplary embodiment of the present invention.

As shown in the accompanying FIG. 2, the integrated signal processing apparatus 10 according to the exemplary embodiment of the present invention includes a first processing unit 11 and a second processing unit 12.

The first processing unit 11 acquires address information from a terminal, and stores and manages the acquired address information of the terminal or forwards it to the user management server 20 so as to be registered and managed therein. Specifically, when the location address has changed because the subscriber network to be connected has changed as the terminal 3 accesses the IP network 1 or moves to another network, the terminal 3 binds its unique address and location address and provides them to the first processing unit 11 of the integrated signal processing apparatus 10. The first processing unit 11 registers the thus-acquired unique address and location address of the terminal by itself, or provides them to the user management server 20 to have them managed.

The address information of a terminal according to the exemplary embodiment of the present invention is configured to have a dual address system including a unique address uniquely assigned to the terminal and a location address assigned to the terminal depending on the location of a wired or wireless subscriber network to which the terminal is connected. As used herein, the unique address refers to information that is assigned from a communication service provider when subscribing to the service for the first time or is assigned from a dynamic host configuration protocol (DHCP; not shown) when connecting to a network, and is used to identify the terminal. The unique address may be an IP address (terminal ID).

The address information of the terminal may be managed corresponding to the user identification information, i.e., user ID, to identify the user of the corresponding terminal. The user ID is unique information for identifying the user when the user subscribes to a network service (e.g., a wired Internet service or the like). The user ID and the unique address are used in an authentication process when connecting to the network. The location address is used as a transport address to which data traffic is actually transmitted, so it may be referred to as a transport address. When the terminal 3 accesses the network or moves to another network, the location address changes depending on the subscriber network to be connected, and the changed location address and the unique address are bound and then stored, registered, and managed in the user management server 20 and the integrated signal processing apparatus 10.

The user ID is a unique ID that recognizes a user created when a subscriber subscribes to a network service. The user ID has to be registered along with the unique address of the terminal in the user management server 20, or has to be registered along with the unique address and transport address of the terminal in the user management server 20. When the user accesses the network, they have to be authenticated using the corresponding user ID and the unique address (IP address) of the corresponding terminal. The unique address, which requires an E.164 number assigned to the corresponding line in a PSTN network to access the network, allows only an IP terminal assigned a unique address to be permitted access to the network, thereby reinforcing the security of the network.

The first processing unit 11 establishes an IP connection based on address information of terminals of first and second users in response to a request for a call with the second user terminal from the first user terminal. Concretely, an IP connection is established between the terminal of the first user, i.e., the first user terminal (e.g., 3-1), and the terminal of the second user, i.e., the second user terminal (e.g., 3-2).

The second processing unit 12 provides a requested service between the ends between which a network connection, including the IP connection, has been established by the first processing unit 11. That is, IP-based services, including VoIP calls, streaming data transfer service, etc., are registered between the terminals, and data traffic using the protocol of an application corresponding to the registered services is permitted to enter so that data traffic corresponding to a requested service is transferred between the terminals.

Next, a method for integrated signal processing according to an exemplary embodiment of the present invention will be described on the basis of the above-described structure.

First, integrated signal processing for a VoIP call between a first user and a second user will be described in the exemplary embodiment of the present invention.

When the location address has changed because the subscriber network to be connected has changed as the terminal of the first user, i.e., the first user terminal 3-1, and the terminal of the second user, i.e., the second user terminal 3-2 access the IP network 1 or move to another network, they bind their unique address and location address and provide them. The bound unique address and location address of each terminal are forwarded to the integrated signal processing apparatus 10 through the network access device 4, and stored and managed in the integrated signal processing apparatus 10 or/and provided to the user management server 20 to be stored, registered, and managed therein.

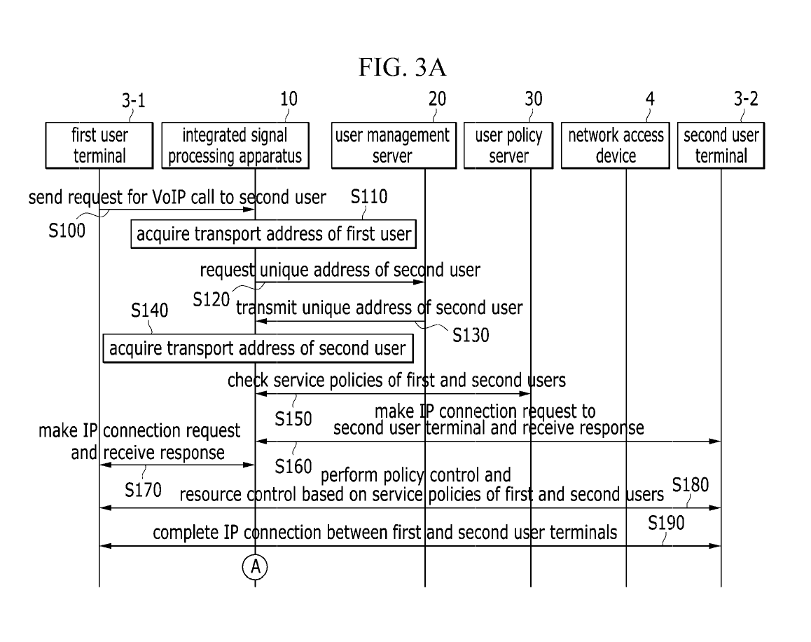

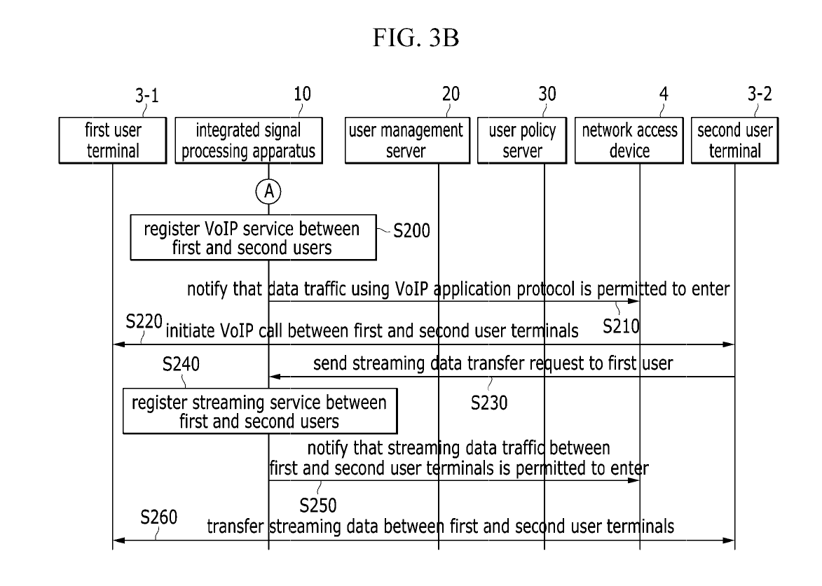

Among the terminals whose address information is managed by the integrated signal processing apparatus 10 connected to the IP network 1 and/or the user management server 20 when the first user terminal 3-1 wants to make a VoIP call to the second user terminal 3-2, the following processing will be performed as shown in FIGS. 3A and 3B. Herein, it is assumed that the authentication process of the first user terminal 3-1 and the second user terminal 3-2 has already been performed.

FIGS. 3A and 3B are flowcharts of a method for integrated signal processing for a VoIP call according to a first exemplary embodiment of the present invention.

As shown in FIG. 3B, first of all, the first user terminal 3-1 sends the integrated signal processing apparatus 10 a request for a VoIP call to the second user terminal 3-2 (S100). In this case, a call request message for the VoIP call is sent to the integrated signal processing apparatus 10 connected to the IP network 1 through a network access device (e.g., 4-1) of a subscriber network accessed by the first user terminal 3-1, and the call request message contains the location address, i.e., transport address of the first user, which is the source address, and the ID of the second user, which is the destination.

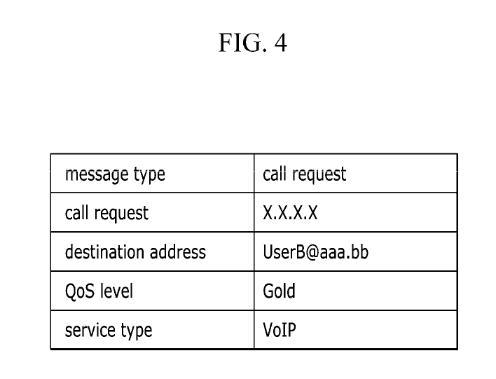

FIG. 4 is a view showing a structure of a call request message according to an exemplary embodiment of the present invention.

In the accompanying FIG. 4, a call request message according to the exemplary embodiment of the present invention includes a source address and a destination ID. That is, the call request message contains the location address, i.e., transport address, of the first user terminal 3-1, which is a call originating source, and the ID of the second user, which is a target destination of the call. Herein, the ID of the second user may be a character string or a URI (userb@aaa.bbb).

Further, the call request message contains an available QoS level and a service type representing the type of requested application service. Herein, the service type is “VoIP” because the user has requested a VoIP call. Further, if the service type is VPN, the integrated signal processing apparatus 10 can set up a VPN between the first and second user terminals, and can set up resources required for VPN.

Upon receipt of a call request message including the above-described information, the integrated signal processing apparatus 10 acquires the transport address of the first user terminal 3-1 and the ID of the second user from the received call request message as shown in FIG. 3a (S110). Also, the integrated signal processing apparatus 10 forwards the acquired ID of the second user to the user management server 20 and requests the unique address of the second user terminal 3-2 (S120). The user management server 20 searches the user database 21 based on the ID of the second user provided from the integrated signal processing apparatus 10, acquires the unique address of the terminal corresponding to the ID of the second user, and transmits it to the integrated signal processing apparatus 10 (S130).

The integrated signal processing apparatus 10 acquires the unique address of the second user, which is the call target, and then acquires the location address, i.e., transport address, bound with the unique address, of the second user, from the address information of the terminals managed by the first processing unit 11 itself (S140). Accordingly, the integrated signal processing apparatus 10 acquires the address information, i.e., unique address and transport address, of the second user.

Next, the integrated signal processing apparatus 10 checks the service policies of the first and second users to set up a session between the first user terminal 3-1 and the second user terminal 3-2. To this end, the integrated signal processing apparatus 10 transmits the ID of the first user and the ID of the second user to the user policy server 30, and acquires information about the service policies of the users. The user policy server 30 searches the policy database 31 based on the ID of the first user and the ID of the second user, and finds service policy control information about resource allocation, the allowed amount of traffic, etc. corresponding to the ID of the first user and the ID of the second user and transmits it to the integrated signal processing apparatus 10 (S150).

After checking the service policies, the integrated signal processing apparatus 10 sends an IP connection request to the second user terminal 3-2 based on the transport address of the second user and receives a response (S160). Also, it sends an IP connection request to the first user terminal 3-1, and receives a response (S170). Upon receiving responses to the IP connection request from the first and second user terminals 3-1 and 3-2, the integrated signal processing apparatus 10 performs policy control and resource control of the first and second user terminals 3-1 and 3-2 (S180).

More specifically, the integrated signal processing apparatus 10 performs service policy control and resource control of the transport addresses of the first and second user terminals 3-1 and 3-2 based on the service policy control information of the first and second users acquired from the user policy server 30.

If the network is in a state such that it is capable of processing the VoIP call service requested by the user, an IP address connection process between the first user terminal 3-1 and the second user terminal 3-2 is completed (S190). Meanwhile, the integrated signal processing apparatus 10 inquires of the user policy server 30 about the QoS level included in the call request message, receives a response as to whether the QoS level meets the service level agreement (SLA) requirements of the corresponding user, and if the QoS level meets the SLA requirements, determines that the network is in a state such that it is capable of processing the VoIP call service requested by the user and completes the IP connection. On the contrary, if the QoS level does not meet the SLA requirements, the corresponding VoIP service is denied, and the IP connection is canceled.

Next, referring to FIG. 3B, the integrated signal processing apparatus 10 registers a VoIP service between the first user terminal 3-1 and the second user terminal 3-2 (S200). Then, the network access device 4 of each subscriber network is notified that traffic using the corresponding application protocol is permitted to enter (S210). Here, the integrated signal processing apparatus 10 stores the fact that the VoIP service has been performed corresponding to the VoIP service-related information between the first and second user terminals 3-1 and 3-2, i.e., the address information, service policy control information, etc. of the first and second user terminals.

As a result, an end-to-end VoIP communication, i.e., a VoIP communication between the first user terminal 3-1 and the second user terminal 3-2, is enabled (S220). The network access device 4 of the subscriber network determines whether to permit the entry of certain VoIP traffic using 5-tuple information (source address, destination address, protocol, source port, and destination port) included in the IP header of a VoIP traffic packet using the corresponding application protocol for a VoIP communication.

While VoIP data traffic is being transmitted and received between the first user terminal 3-1 and the second user terminal 3-2, if the second user terminal 3-2 sends a request for transfer of streaming data, such as video, to the first user terminal 3-1 (S230), the integrated signal processing apparatus 10 checks whether the IP connection between the first user terminal 3-1 and the second user terminal 3-2 is being maintained. If the IP connection is being maintained, a streaming service enabling streaming data transfer between the first user terminal 3-1 and the second user terminal 3-2 is registered without any particular process (S240), and the network access device 4 of the subscriber network accessed by the second user terminal is notified that traffic using an application protocol for streaming data transfer is permitted to enter (S250). As a result, the network access device 4 permits traffic using the corresponding application protocol to enter, and, in this case as well, it can be determined whether to permit the entry of the corresponding traffic using 5-tuple information included in the header of the received traffic. Accordingly, streaming data is transferred between the first user terminal 3-1 and the second user terminal 3-2 (S260).

Next, a method for integrated signal processing for a VoIP call between a first user and a second user according to a second exemplary embodiment of the present invention will be described.

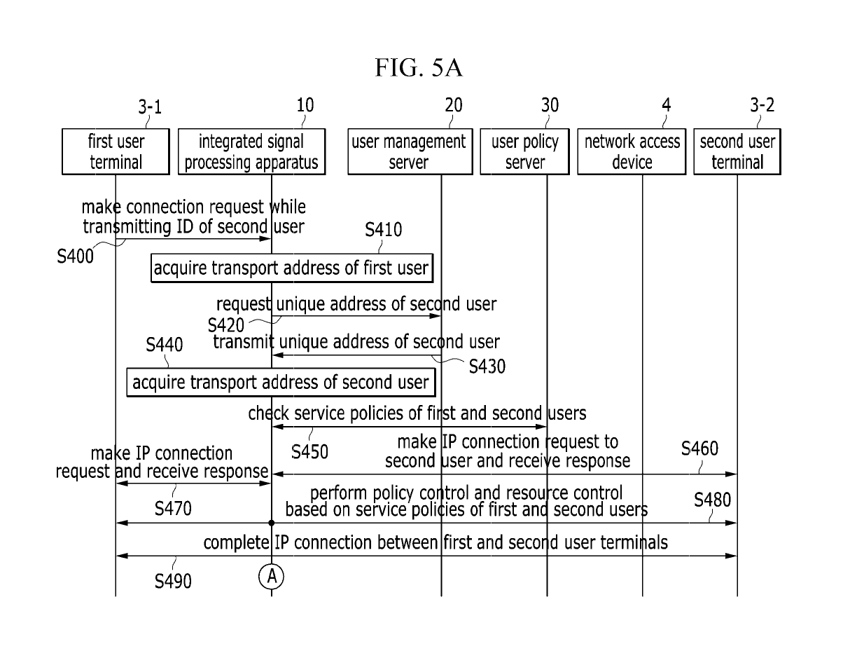

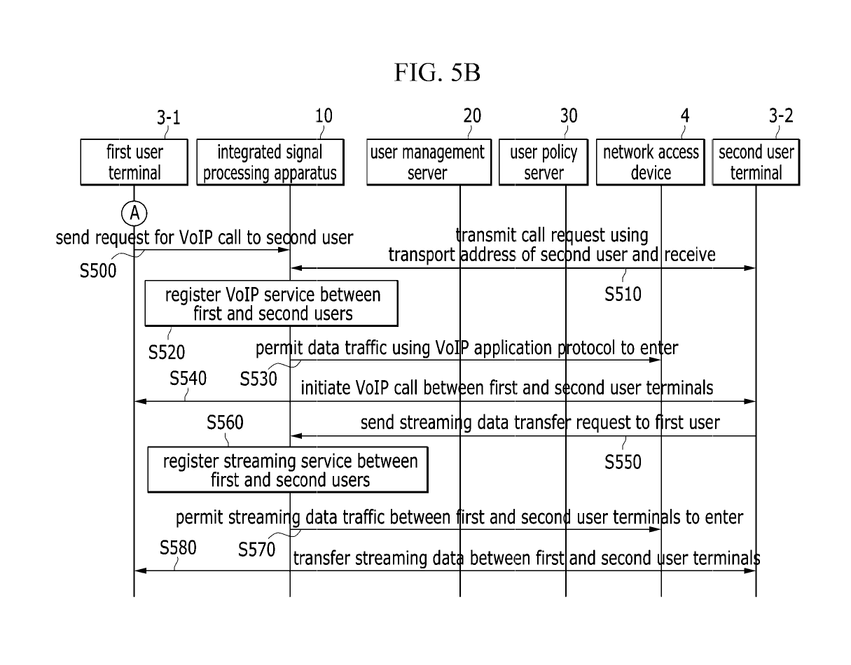

FIGS. 5A and 5B are flowcharts of a method for integrated signal processing for a VoIP call according to a second exemplary embodiment of the present invention.

In the integrated signal processing method according to the second exemplary embodiment of the present invention, an IP connection is established between the two terminals in response to a request for a connection with the second user terminal 3-2 from the first user terminal 3-1, and then VoIP service registration is performed in response to a VoIP call request from the first user terminal 3-1.

As shown in the accompanying FIG. 5A, in the integrated signal processing method according to the second exemplary embodiment of the present invention, the integrated signal processing apparatus 10 receives the request for a connection with the second user terminal 3-2 from the first user terminal 3-1. In this case, the first user terminal 3-1 makes a connection request while transmitting the ID of the second user to which it wants to connect (S400).

In response to the connection request from the first user terminal 3-1, like the first exemplary embodiment, the integrated signal processing apparatus 10 acquires the transport address of the first user terminal 3-1, acquires the unique address of the second user terminal 3-2 from the user policy server 20 based on the ID of the second user transmitted from the first user terminal 3-1, and acquires the transport address of the second user based on the acquired unique address (S420-S440). Then, the integrated signal processing apparatus 10 acquires service policy control information of the first and second users through the policy server 30, and performs policy control and resource allocation control while establishing an IP connection between the first user terminal 3-1 and the second user terminal 3-2 (S450-S490).

After the IP connection between the first user terminal 3-1 and the second user terminal 3-2 is established through this process, the first user terminal 3-1 makes a VoIP call request according to the second exemplary embodiment of the present invention. That is, while the first exemplary embodiment has been described with respect to a case where the integrated signal processing apparatus 10 registers a VoIP service between the first user terminal 3-1 and the second user terminal 3-2 upon completion of the IP connection without any particular process, the second exemplary embodiment has been described with respect to a case where a service corresponding to a service request from the first user terminal 3-1 is provided because only an IP connection has been established in response to the connection request from the first user terminal 3-1. The invention has been described here with respect to an example in which the VoIP service is registered when the first user terminal 301 makes a VoIP call request and the second user terminal 3-2 accept the request.

More specifically, after completing the IP connection, as shown in FIG. 5B, upon receipt of a call request message requesting a VoIP call with the second user terminal 3-2 from the first user terminal 3-1 (S500), the integrated signal processing apparatus 10 checks the transport address of the second user terminal 3-2, and then requests the second user terminal 3-2 to establish a VoIP call with the first user terminal 3-1. Afterwards, upon receipt of a response to the VoIP call request from the second user terminal 3-2 (S510), the integrated signal processing apparatus 10 registers a VoIP call service between the first user terminal 3-1 and the second user terminal 3-2 (S520).

When this service registration process is completed, the call signal processing apparatus 10 notifies the network access device 4 accessed by the first and second user terminals 3-1 and 3-2 that traffic using an application protocol for a VoIP call is permitted to enter (S530), like the first exemplary embodiment, and initiates a VoIP call between the first user terminal 3-1 and the second user terminal 3-2 (S540).

Afterwards, when a streaming data transfer request is received from the first user terminal 3-1, like the first exemplary embodiment, a streaming service is registered and traffic using the corresponding application protocol is permitted to enter, so that streaming data transfer is performed between the first user terminal 3-1 and the second user terminal 3-2 (S550-S580).

According to these exemplary embodiments of the present invention, in a convergence network having wired and wireless networks integrated therein, control over VoIP calls and streaming services between terminals is done regardless of wired and wireless networks, and a network layer-based integrated signal processing optimized for IP packet exchange for this service is performed. Moreover, end-to-end security communication can be ensured by storing and managing address information of a terminal separately by the unique address and transport address (locator) of the terminal. On the basis of such integrated signal processing, security control, mobility control, connection control, QoS control, and VPN control can be performed on a single integrated protocol, and a procedure for performing each control can be simplified and the structure of a control layer can be simplified. Therefore, end-to-end seamless secured service continuity for SIP/non-SIP services can be provided in a wired and wireless integrated environment.

A structure of a message used for registering a service between first and second users in the integrated signal processing according to an exemplary embodiment of the present invention will be discussed below.

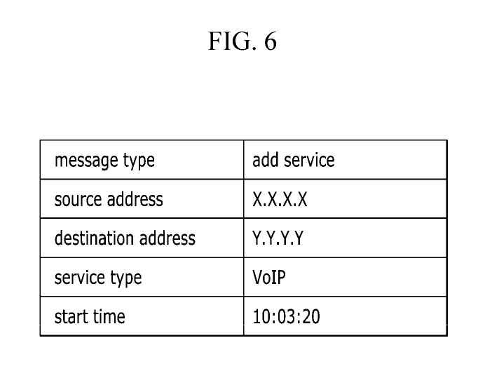

FIG. 6 is a view showing a structure of a service registration message according to an exemplary embodiment of the present invention.

As shown in the accompanying FIG. 6, a service registration message according to an exemplary embodiment of the present invention has a message type “ADD service”, and includes the transport address of the first user terminal 3-1 to which the service is provided, and the transport address of the second user terminal 3-2. Further, type information (e.g., VoIP, streaming data transfer, etc.) of a registered service and service start time when the service is started are included.

Meanwhile, in the case of termination of the corresponding service, a service release message can be used, and the service release message, like the service registration message, includes a message type (e.g., “DELETE service”), the transport address of the first user terminal provided with the service, and the transport address of the second user terminal, and may include service end time instead of start time.

The service registration message and service release message can be provided to the integrated signal processing apparatus 10 from the first user terminal 3-1, and the integrated signal processing apparatus 10 having received the service registration message and the service release message perform the registration and release of the service requested by a user. For example, in the above first and second exemplary embodiments, a service registration message can be used in the service registration step (S210, S530).

Also, the integrated signal processing apparatus 10 extracts the start time from the service registration message, extracts the end time from the service release message, and then transmits the extracted start and end times and the ID of the first user who has requested the service to a billing system (not shown), thereby charging a fee for the service used by the user.

According to an exemplary embodiment of the present invention, security control, mobility control, connection control, QoS control, and VPN control can be performed on a single integrated protocol, thus simplifying control processing and the structure of a control layer. Therefore, end-to-end seamless secured service continuity for SIP/non-SIP services can be provided in a wired and wireless integrated environment.

Moreover, end-to-end security communication is ensured by separating the unique address of a terminal and the transport address (locator) thereof, which is refreshed when the terminal moves, and an IP-based seamless mobile service can be provided.

The exemplary embodiments of the present invention are not implemented only by a device and/or method, but can be implemented through a program for realizing functions corresponding to the configuration of the exemplary embodiments of the present invention and a recording medium having the program recorded thereon. Such implementation can be easily made by a skilled person in the art to which the present invention pertains from the above description of the exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for integrated signal processing, in which, in a convergence network having wired and wireless networks connected to an IP network, an integrated signal processing apparatus connected to the IP network performs call processing between terminals, the method comprising:
acquiring a unique address and transport address of a second user terminal based on an ID of a e second user acquired from a first user terminal connected to the wired network or the wireless network;
sending an IP connection request to the first user terminal and the second user terminal respectively corresponding to the acquired transport addresses;
receiving responses to the IP connection request from the first user terminal and the second user terminal, and completing an IP connection between the first user terminal and the second user terminal based on service policy control information of the first and second user terminals;
registering a service corresponding to a request from the first user terminal; and
permitting transmission and reception of data traffic corresponding to the registered service between the first user terminal and the second user terminal.

2. The method of claim 1, wherein,
in the acquiring of the ID of the second user, the ID of the second user is acquired from a call request message sent from the first user terminal, and
the call request message comprises the transport address of the first user and the ID of the second user.

3. The method of claim 2, wherein the call request message further comprises a QoS (quality of service) level, and
the method further comprises the integrated signal processing apparatus' inquiring of a user policy server regarding the QoS level included in the call request message and receiving a response as to whether the QoS level meets SLA (service level agreement) requirements of the corresponding user,
wherein, in the completing of the IP connection, if the QoS level meets the SLA requirements, determining that the service requested by the user can be processed.

4. The method of claim 1, wherein, in the acquiring of the ID of the second user, the ID of the second user is acquired from the first user terminal requesting a connection to the second user terminal while transmitting the ID of the second user.

5. The method of claim 1, wherein, in the registering of a service, a service request for an end-to-end data transfer service including a VoIP (voice over Internet protocol) service is transmitted to the second user in response to the service request from the first user, and the corresponding service is registered after a response from the second user.

6. The method of claim 5, wherein the registering of a service comprises, after the completion of the IP connection between the first user terminal and the second user terminal:
receiving a VoIP call request by the second user terminal from the first user terminal;
forwarding the VoIP call request from the first user terminal to the second user terminal; and,
upon receipt of a response to the VoIP call request from the second user terminal, registering a VoIP call service between the first user terminal and the second user terminal.

7. The method of claim 1, wherein the unique address is an IP address uniquely assigned to a terminal to identify the terminal, the transport address is a location address assigned to the terminal depending on the location of a wired or wireless subscriber network accessed by the terminal, and the unique address and the transport address are bound, stored, and managed.

8. The method of claim 1, wherein the permitting of transmission and reception of data traffic comprises:
notifying network access devices of subscriber networks respectively accessed by the first and second user terminals that data traffic using an application protocol corresponding to the registered service is permitted to enter; and
performing data traffic transmission and reception between the first user terminal and the second user terminal.

9. The method of claim 1, wherein the registering of a service further comprises:
receiving a streaming data transfer request from the second user terminal; and,
if an IP connection is maintained between the first user terminal and the second user terminal, registering a streaming service between the first user terminal and the second user terminal,
wherein the permitting of transmission and reception of data traffic further comprises:
notifying network access devices of subscriber networks respectively accessed by the first and second user terminals that data traffic using an application protocol corresponding to the streaming service is permitted to enter; and
performing streaming data transfer between the first user terminal and the second user terminal.

10. The method of claim 1, further comprising:
receiving a service registration message from the first user terminal, the service registration message including the transport address of the first user terminal to be provided with the service, the transport address of the second user terminal, and a service start time; and
receiving a service release message from the first user terminal, the service release message including the transport address of the first user terminal to be provided with the service, the transport address of the second user terminal, and a service end time.

11. The method of claim 10, wherein the integrated signal processing apparatus requests a billing server to charge for service usage based on the service start time acquired from the service registration message and the service end time acquired from the service release message.

12. The method of claim 6, wherein the permitting of transmission and reception of data traffic comprises:
notifying network access devices of subscriber networks respectively accessed by the first and second user terminals that data traffic using an application protocol corresponding to the registered service is permitted to enter; and
performing data traffic transmission and reception between the first user terminal and the second user terminal.

13. The method of claim 6, wherein the registering of a service further comprises:
receiving a streaming data transfer request from the second user terminal; and,
if an IP connection is maintained between the first user terminal and the second user terminal, registering a streaming service between the first user terminal and the second user terminal,
wherein the permitting of transmission and reception of data traffic further comprises:
notifying network access devices of subscriber networks respectively accessed by the first and second user terminals that data traffic using an application protocol corresponding to the streaming service is permitted to enter; and
performing streaming data transfer between the first user terminal and the second user terminal.

14. The method of claim 6, further comprising:
receiving a service registration message from the first user terminal, the service registration message including the transport address of the first user terminal to be provided with the service, the transport address of the second user terminal, and a service start time; and
receiving a service release message from the first user terminal, the service release message including the transport address of the first user terminal to be provided with the service, the transport address of the second user terminal, and a service end time.

15. An apparatus for integrated signal processing, which, in a convergence network having wired and wireless networks connected to an IP network, is connected to the IP network to process signals, the apparatus comprising:
a first processing unit that establishes an IP connection between a first user terminal and a second user terminal based on address information of the first and second user terminals in response to a request for a service call with the second user terminal from the first user terminal connected to the wired network or wireless network; and
a second processing unit that registers a service between the first and second user terminals between which the IP connection is established, permits data traffic using the protocol of an application corresponding to the registered service to enter, and performs data traffic transfer for the requested service between the terminals.

16. The apparatus of claim 15, wherein the address information of a terminal includes a unique address, which is an IP address uniquely assigned to the terminal to identify the terminal, and a transport address, which is a location address assigned to the terminal depending on the location of a wired or wireless subscriber network accessed by the terminal.

17. The apparatus of claim 16, wherein the first processing unit acquires, from a user policy server, the unique address corresponding to the ID of the second user provided from the first user terminal, and acquires the transport address of the second user corresponding to the acquired unique address based on the address information of the terminals being stored and managed.

18. The apparatus of claim 16, wherein, after completion of the IP connection between the first user terminal and the second user terminal, the second processing unit registers the corresponding service between the first and second user terminals in response to a request from the first user terminal.

19. The apparatus of claim 18, wherein the second processing unit receives a VoIP call request from the first user terminal and forwards the same to the second user terminal, and upon receipt of a response from the second user terminal, registers a VoIP call service between the first user terminal and the second user terminal.
